(19) United States
(12) Patent Application Publication
(10) Pub. No.: US 2015/0012433 A1
(43) Pub. Date: Jan. 8, 2015

(54) MOBILE IDENTITY

(71) Applicants: Jun Yang, San Jose, CA (US); Zhenyin Yang, Saratoga, CA (US); Steven Romero, Protland, OR (US); Anthony Shah, Santa Clara, CA (US); Ladd Van Tol, Portland, OR (US)

(72) Inventors: Jun Yang, San Jose, CA (US); Zhenyin Yang, Saratoga, CA (US); Steven Romero, Protland, OR (US); Anthony Shah, Santa Clara, CA (US); Ladd Van Tol, Portland, OR (US)

(21) Appl. No.: 14/098,126

(22) Filed: Dec. 5, 2013

Related U.S. Application Data
(60) Provisional application No. 61/842,602, filed on Jul. 3, 2013.

(51) Int. Cl. G06Q 20/40

(52) U.S. Cl. CPC G06Q 20/40
USPC 705/44; 705/35

(57) ABSTRACT

A user may have multiple online identities used to access multiple online services. The user may use the multiple online identities from a device. The system may detect that the multiple online identities connect from the device and determine that the multiple online identities are all associated with the user. Based on the common identification, various features may be enabled, including fraud detection and targeted advertising.

### CROSS-REFERENCE TO RELATED APPLICATIONS

This application claims the benefit of U.S. Provisional Application No. 61/842,602, filed Jul. 3, 2013, entitled “MOBILE IDENTITY,” which is incorporated herein by reference in its entirety.

### TECHNICAL FIELD

The subject matter disclosed herein generally relates to user accounts in electronic systems. Specifically, in one example, the present disclosure addresses a unified mobile identity for multiple user accounts.

### BACKGROUND

A user may have one electronic identity associated with one or more online services and a different electronic identity associated with other online services. Under some circumstances, a user may have multiple electronic identities associated with the same online service.

Each online service may separately gather information about the user and the user's corresponding electronic identity. Each online service may use the information it has about the user to customize the user experience.

### BRIEF DESCRIPTION OF THE DRAWINGS

Some embodiments are illustrated by way of example and not limitation in the figures of the accompanying drawings.

FIG. 1 is a block diagram illustrating an example of a network environment for implementing mobile identities, according to example embodiments.

FIG. 2 is a block diagram illustrating components of a service providing machine for implementing mobile identities, according to example embodiments.

FIG. 3 is a block diagram illustrating components of a mobile identity machine for implementing mobile identities, according to example embodiments.

FIG. 4 is a block diagram illustrating data relationships for implementing mobile identities, according to example embodiments.

FIG. 5 is a block diagram illustrating data relationships for implementing mobile identities, according to example embodiments.

FIG. 6 is a block diagram illustrating data relationships for implementing mobile identities, according to example embodiments.

FIG. 7 is a block diagram illustrating data relationships for implementing mobile identities, according to example embodiments.

FIG. 8 is a block diagram illustrating data relationships for implementing mobile identities, according to example embodiments.

FIG. 9 is a flow diagram illustrating operations of implementing mobile identities, according to example embodiments.

FIG. 10 is a flow diagram illustrating operations of implementing mobile identities, according to example embodiments.

FIG. 11 is a simplified block diagram of a machine in an example form of a computing system within which a set of instructions for causing the machine to perform any one or more of the methodologies discussed herein may be executed.

### DETAILED DESCRIPTION

Example methods and systems are directed to providing a mobile identity. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident, to one skilled in the art, however, that the present subject matter may be practiced without these specific details.

A user may have multiple accounts with multiple computer-provided services. For example, a user may have an account on an ecommerce site that is primarily used for selling items and a second account on the same site or a different site that is primarily used for buying items. As another example, a user may have an account with a financial institution that is primarily used for personal transactions and a second account with the same financial institution or a different financial institution that is primarily used for business transactions. That the multiple accounts are all associated with the user may be determined by recognizing patterns in the way the multiple accounts are accessed. For example, since mobile phones are typically predominantly used by a single individual, a connection from a single mobile phone to accounts on multiple services may suggest that each of those connections originates from a single user. Other example embodiments may determine user identity based on commonality of transactions or assets or other criteria. For example, two distinct financial accounts may each be linked to receive funds from a single source, which may suggest that the two financial accounts are controlled by a same user, controlled by the user as the source of the funds, or both.

A service provider provides one or more services to one or more users. For example, the ecommerce site and financial institutions discussed above are service providers. An identity provider provides information regarding one or more users to one or more service providers. An identity provider may also be a service provider.

A service provider may communicate with an identity provider to request additional information about the user corresponding to a user account of the service provider, to provide information about the account, or both. The identity provider may respond with additional information about the user, store the information about the account, or both. The user may be presented with one or more options to enable the user to control the use of information. For example, a user may opt to prevent the service provider from sharing any information with the identity provider or other service providers, may opt to allow the service provider to share information with selected identity or service providers, may opt to allow the sharing of specific information with any provider, or may opt to allow the sharing of specific information with selected identity or service providers.

Based on a determination that multiple accounts are associated with a single user, various features may be enabled. For example, fraud by an account of a user may trigger heightened sensitivity to potential fraud by other accounts of the user. As another example, interests associated with an account of a user may trigger presentation of advertisements related to those interests to another account of the user.

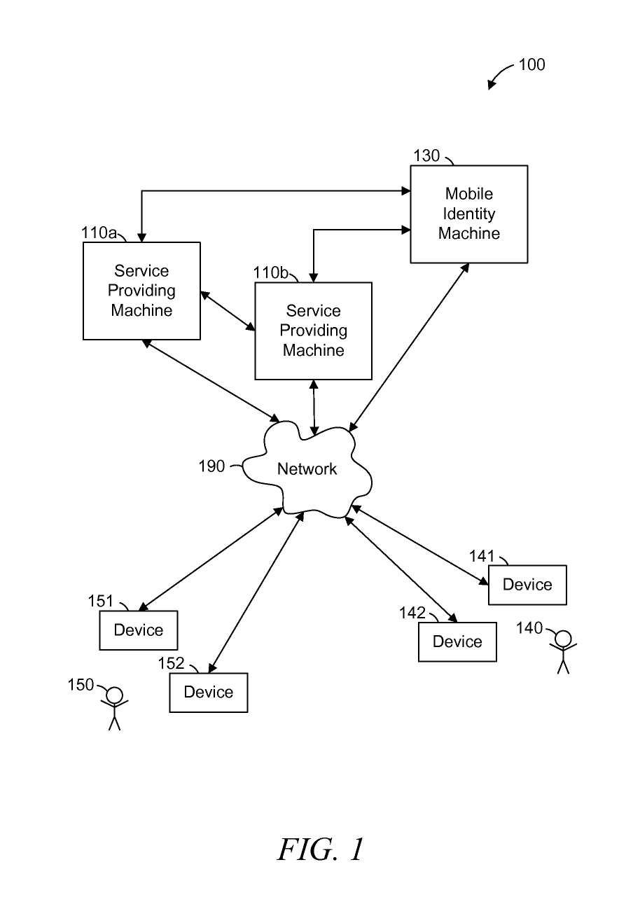

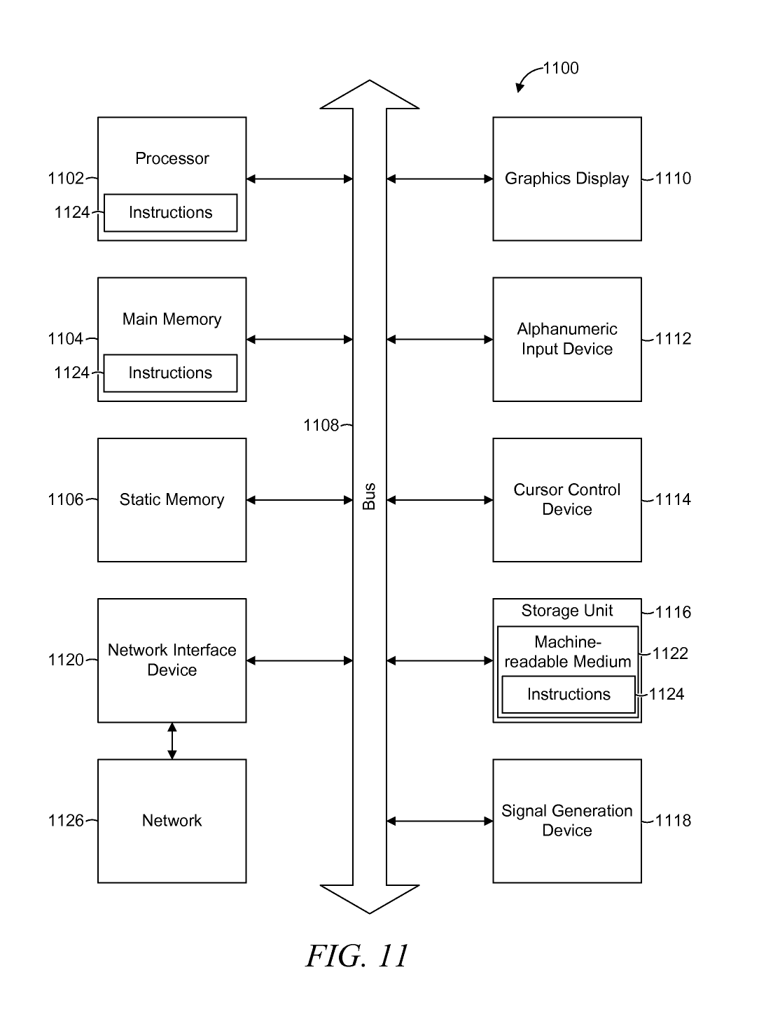

FIG. 1 is a block diagram illustrating an example of a network environment 100 for implementing particular disclosed example embodiments. The network environment 100 includes a service providing machine 110a, a service providing machine 110b, a mobile identity machine 130, and devices 141, 142, 151, and 152, all communicatively coupled to each other via a network 190. The service providing machines 110, mobile identity machine 130, and devices 141, 142, 151, and 152 may each be implemented in a computer system, in whole or in part, as described below with respect to FIG. 11.

The devices 141, 142, 151, and 152 may be used by users 140 and 150 to access services provided by the service providing machines 110 (e.g., the service providing machine 110a and the service providing machine 110b). The service providing machines 110 may provide services such as financial or banking services, social networking services, retail or wholesale services, communication services, or other services. The service providing machines 110 may access the mobile identity machine 130 to gather additional information about the users 140 and 150, to provide information about the users 140 and 150, or both.

For example, the user 150 may access the service providing machine 110a using the device 151. The service providing machine 110a may then inform the mobile identity machine 130 of the access and request information from the mobile identity machine 130. The mobile identity machine 130 may not have any information about the user 150, and inform the service providing machine 110a of this lack of information. The user 150 may then access a second service providing machine 110b using the device 151. The second service providing machine 110b may then inform the mobile identity machine 130 of the access and request information from the mobile identity machine 130. The mobile identity machine 130 may inform the second service providing machine 110b of the previous access from the same device 151 to the first service providing machine 110a. Based on this information, the second service providing machine 110b may alter the services provided to the user 150. For example, products offered or advertisements presented may be altered based on the information provided by the mobile identity machine 130. As a more specific example, if the first service providing machine 110a provides a service relating to a particular sport and the second service providing machine 110b provides a retail service, the second service providing machine 110b may provide advertisements related to the sport to the user 150 that uses both services. In some example embodiments, the second service providing machine 110b may also communicate with the first service providing machine 110a to gather additional information regarding the user 150.

In another example, the user 150 may access the service providing machine 110a using the device 151. The service providing machine 110a may then inform the mobile identity machine 130 of the access and request information from the mobile identity machine 130. The mobile identity machine 130 may not have any information about the user 150, and inform the service providing machine 110a of this lack of information. The user 150 may then access the service providing machine 110a using the device 152. The service providing machine 110a may then inform the mobile identity machine 130 of the access and request information from the mobile identity machine 130. The mobile identity machine 130 may inform the service providing machine 110a of the previous access from the different device 151 to the service providing machine 110a. Based on this information, the service providing machine 110a may alter the services provided to the user 150. For example, products offered or advertisements presented may be altered based on the information provided by the mobile identity machine 130. As a more specific example, connecting from multiple devices 151, 152 may correlate with a certain economic status, and advertisements may be more narrowly targeted based on this correlation.

One or both of the users 140 and 150 may be a human user, a machine user (e.g., a computer configured by a software program to interact with one or more of the devices 141, 142, 151, and 152), or any suitable combination thereof (e.g., a human assisted by a machine or a machine supervised by a human). The user 140 is not part of the network environment 100, but is associated with the devices 141 and 142 and may be a user of the devices 141 and 142. For example, the devices 141 and 142 may each be a desktop computer, a vehicle computer, a tablet computer, a navigational device, a portable media device, or a smart phone belonging to the user 140. Likewise, the user 150 is not part of the network environment 100, but is associated with the devices 151 and 152. As an example, the devices 151 and 152 may each be a desktop computer, a vehicle computer, a tablet computer, a navigational device, a portable media device, or a smart phone belonging to the user 150.

Any of the machines or devices 141, 142, 151, 152 shown in FIG. 1 may be implemented in a general-purpose computer modified (e.g., configured or programmed) by software to be a special-purpose computer to perform the functions described herein for that machine or device 141, 142, 151, 152. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines or devices 141, 142, 151, 152 illustrated in FIG. 1 may be combined into a single machine, and the functions described herein for any single machine or device 141, 142, 151, 152 may be subdivided among multiple machines or devices 141, 142, 151, 152.

The network 190 may be any network that enables communication between or among machines and devices (e.g., the server machine 110 and the device 141). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

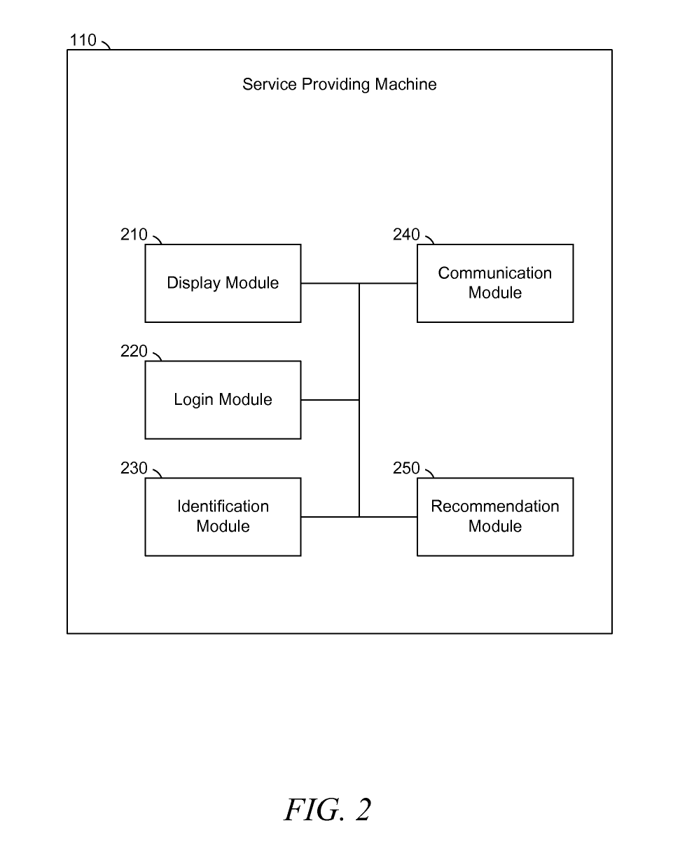

FIG. 2 is a block diagram illustrating components of a service providing machine 110 for implementing particular example embodiments. The service providing machine 110 is shown as including a display module 210, a login module 220, an identification module 230, a communication module 240, and a recommendation module 250, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The display module 210 may be configured to provide a user interface to a user connecting to the service providing machine 110. For example, the service providing machine 110 may serve a web page. The user may respond to the user interface by, for example, logging in with a user name and password.

The login module 220 may initially store and later access the login information provided by the user. For example, the login module 220 may access a database containing one or more records for the user, including the user name and password of the user.

The identification module 230 may use the information provided by the user to identify the user. For example, if a hashed version of the user's password is stored by the login module 220, the identification module 230 may hash the password provided by the user and compare the generated hash with the stored hash, retrieved by the login module 220, to verify that the correct password was entered.

The communication module 240 may communicate information about the user to the mobile identity machine 130, and receive information about the user in response. The communication module 240 may also perform other communication tasks, such as receiving data to be used for generating a user interface with the display module 210 and transmitting requests for web pages or application updates.

The recommendation module 250 may provide recommendations to the user or otherwise alter the user experience. The recommendation may be based on the additional information received by the communication module 240. For example, the communication module 240 may receive information about the user indicating that the user owns a pet. Accordingly, the recommendation module may generate recommendations for pet food and pet toy advertisements, to be presented by the display module 210.

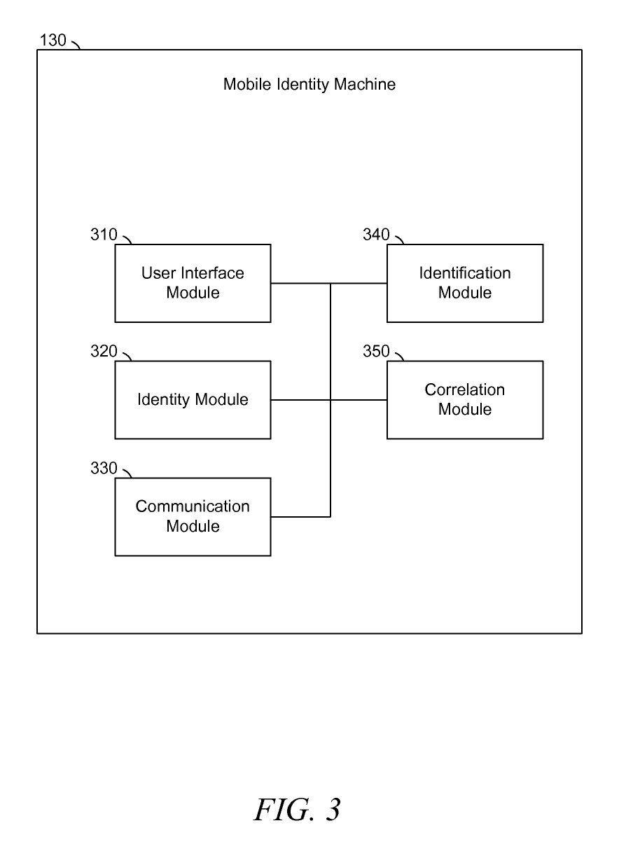

FIG. 3 is a block diagram illustrating components of the mobile identity machine 130 for implementing particular example embodiments. The mobile identity machine 130 is shown as including a user interface module 310, an identity module 320, a communication module 330, an identification module 340, and a correlation module 350, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user interface module 310 may be configured to provide a user interface to a user connecting to the mobile identity machine 130. For example, the mobile identity machine 130 may serve a web page to an administrator. An administrator is an individual, group, or machine able to access or modify information regarding users. The administrator may respond to the user interface by logging in.

The identity module 320 may access stored data regarding user identities and administrators. An administrator may be able to view the user identities of users stored by the identity module 320, modify the data, and change which aspects of the data are available to different service providers, using a user interface provided by the user interface module 310. For example, service providers may pay a fee to a mobile identity service hosting the mobile identity machine 130 and, depending on the amount of the fee paid, the mobile identity service may provide more or less information regarding the user. In some example embodiments, the administrator may control these settings using the user interface presented by the user interface module 310.

The communication module 330 may communicate with one or more of the service providing machines 110 to send and receive information regarding users. The communication module 330 may also perform other communication tasks, such as transmitting data to be used for generating a user interface and receiving requests for web pages or application updates.

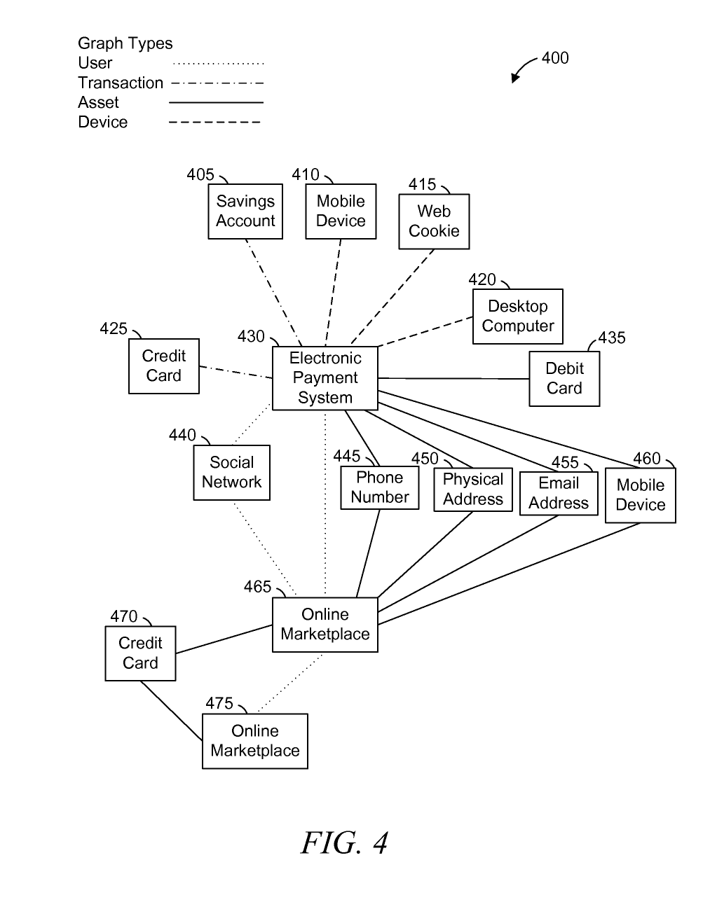

The identification module 340 may determine the identity of the user accessing the service providing machine 110. For example, information provided by the user during the log in process may be provided to the correlation module 350 by the service providing machine 110. Based on a correlation (determined by the correlation module 350) between the information provided and information known about the users, the identity of the connected user may be determined, as discussed in more detail in the discussion of FIGS. 4-10 below. Information regarding the user may be stored by the identity module 320 and accessed by the correlation module 350 and the identification module 340 in the process of identifying the user.

FIG. 4 is a block diagram illustrating data relationships in particular example embodiments. A web of relationships 400 may be used to establish a single identity for a user based on multiple relationships between the user and various services. The types of relationships shown are user relationships, device relationships, transaction relationships, and asset relationships, though other types of relationships may be used. Two user accounts have a user relationship when the same login credentials are used to access both accounts. Two user accounts have a device relationship when one device is used to access both accounts. Two user accounts have a transaction relationship when one funding source is used to fund transactions through both accounts. Two user accounts have an asset relationship when one asset is listed in both accounts.

For example, device relationships are shown between electronic payment system 430 and each of a mobile device 410, a web cookie 415 (stored on a device), and a desktop computer 420. Similarly, transaction relationships are shown between the electronic payment system 430 and a savings account 405 and a credit card 425. Asset relationships are shown between the electronic payment system 430 and phone number 445, physical address 450, email address 455, mobile device 460, and debit card 435. Furthermore, asset relationships are also shown between the online marketplace 465 and phone number 445, physical address 450, email address 455, mobile device 460, and credit card 470. An asset relationship between online marketplace 475 and credit card 470 is also shown. While the user account may only contain information regarding the assets, the user has an ownership or control relationship with the asset. For example, the user owns or controls the mobile device 460 and its associated phone number. Likewise, the user owns or controls the house or apartment at the physical address 450. User relationships are shown between social network 440, electronic payment system 430, online marketplace 465, and online marketplace 475.

When a single account is accessed from multiple devices, each of those multiple devices may be associated with the user of the single account. When the single account transfers funds from multiple financial accounts, each of those multiple financial accounts may be associated with the user of the single account. When separate user accounts have overlapping contact or financial information, the separate user accounts may be associated with a single user. When a single user account is used to access multiple services, information gathered about the single user account by each service may be combined to form a more complete mobile identity for the user.

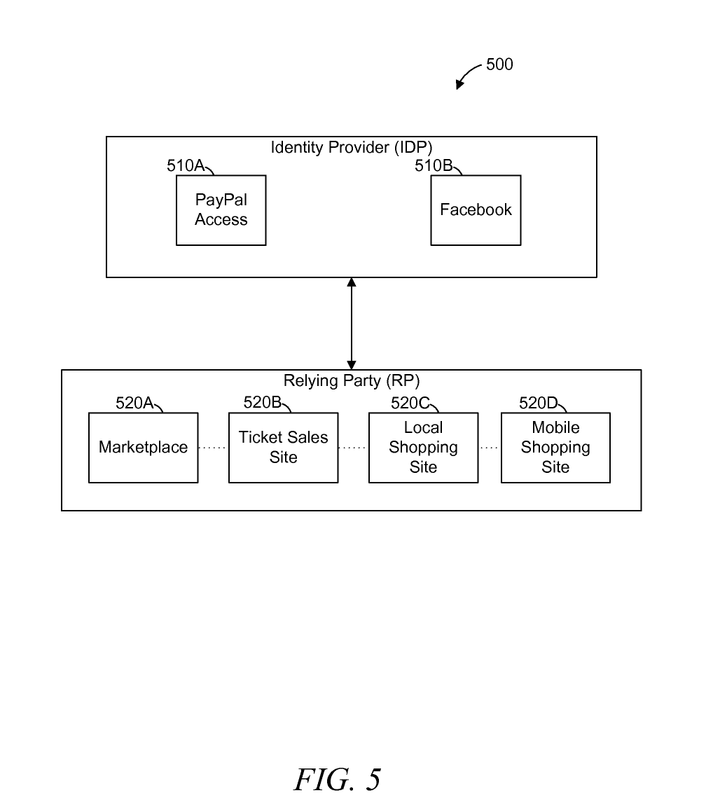

FIG. 5 is a block diagram illustrating data relationships in particular example embodiments. FIG. 5 shows an example embodiment of a network 500 in which each of marketplace 520A, ticket sales site 520B, local shopping site 520C, and mobile shopping site 520D (collectively relying parties 520) comprises an example of the service providing machine 110, and each of PayPal Access 510A and Facebook 510B comprises an example of the mobile identity machine 130. In this example embodiment, each of the relying parties 520 communicates with one or both of the identity providers 510 to share user information. The identity providers 510 may communicate with each other to share the user information they have gathered from the relying parties 520 communicating with them. The relying parties 520 may communicate with each other to share user information corresponding to a user identity retrieved from one or more of the identity providers 510.

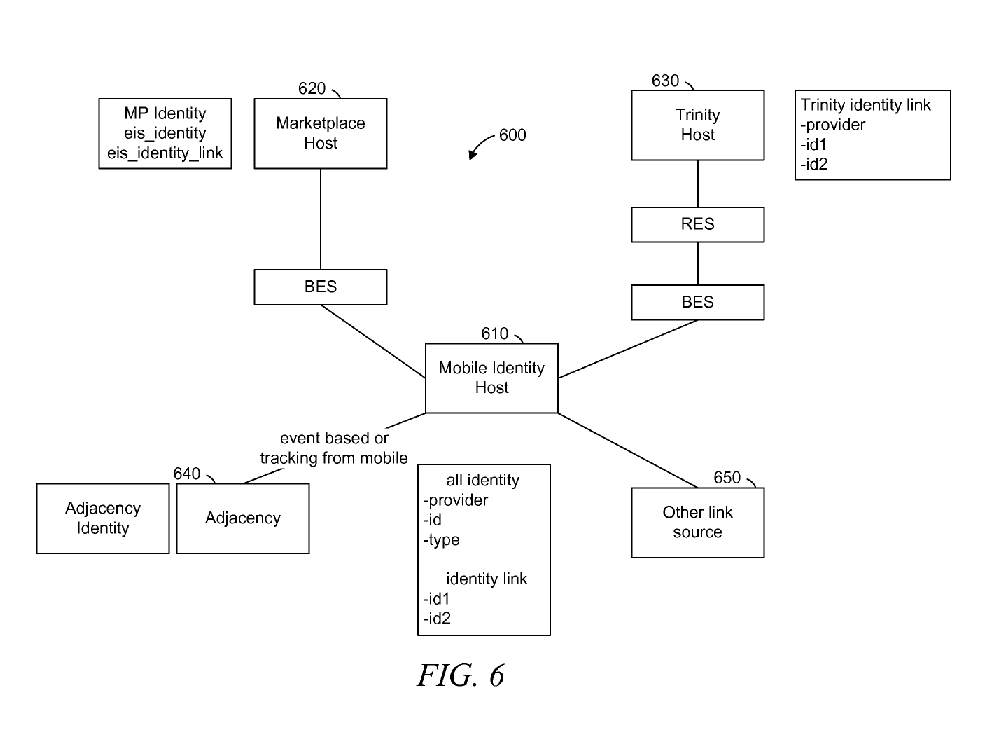

FIG. 6 is a block diagram illustrating data relationships in particular example embodiments. FIG. 6 shows an example embodiment in a network 600. A mobile identity host 610 (e.g., the mobile identity machine 130) may communicate with a trinity host 630 (e.g., a second mobile identity machine 130) and gather information regarding the trinity host 630 and at least two identities for the user. A marketplace host 620 (e.g., the service providing machine 110) may communicate with the mobile identity host 610 and provide information regarding the user gathered in a marketplace hosted by the marketplace host 620. The mobile identity host 610 may also gather information based on adjacency 640 or the use of the same device to access multiple accounts. Additional linking information for the user may also be gathered from another linked source 650. For example, a social network may be the other linked source 650, providing information regarding a user's relationships, assets, and transactions. Accordingly, the mobile identity host 610 may gather a set of information about the user such as the service providers 110 accessed by the user, the user identifier used by the user for each service provider 110, and the type of device used by the user with the user identifier. The mobile identity host 610 may also gather a set of user identifiers (e.g., user names, account numbers, etc.) used by the user to access various services. As a result, one of the other service providing machines (e.g., the marketplace host 620) may access the mobile identity host 610 and access the information stored therein regarding the user based on providing the user identifier used to access the service providing machine. In other example embodiments, additional information regarding the user may be provided.

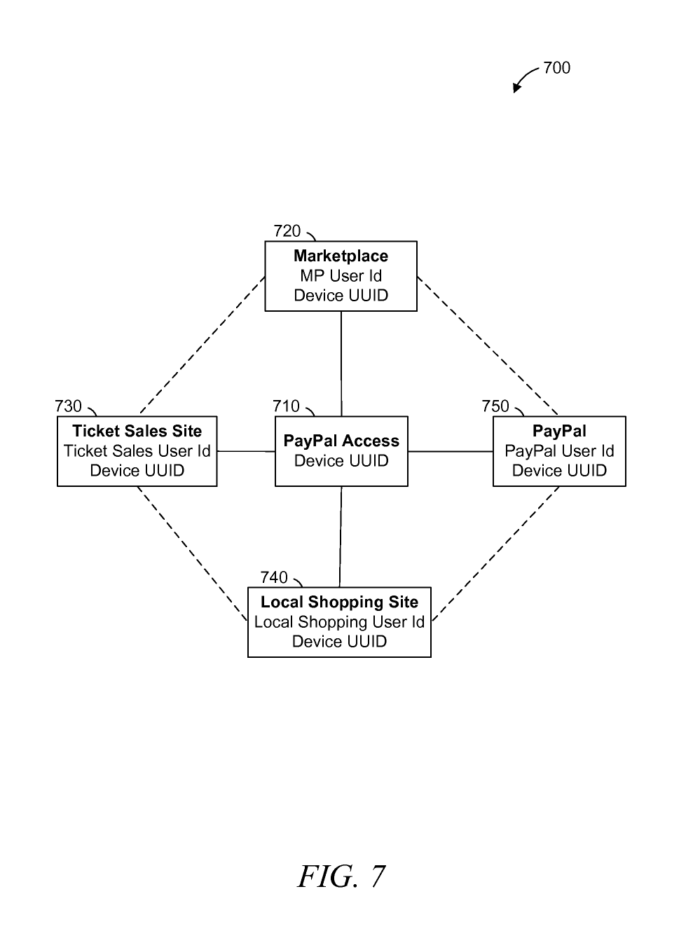

FIG. 7 is a block diagram illustrating data relationships in particular example embodiments. FIG. 7 shows an example embodiment in a network 700. In this embodiment, PayPal Access 710 is a mobile identity machine 130 and marketplace 720, ticket sales site 730, local shopping site 740, and PayPal 750 are the relying parties and service providers. As shown, each of the service providers may have a distinct user ID for the user, while having the same unique identifier (“UUID”) for the device being used to access the service. The dotted lines indicate that each service provider may communicate with the other service providers to gather information for the user. The service provider requesting information may identify the user by the UUID for the device or by using an identity provided by the IDP. Either way, the service provider may gather information about the user aggregated from all of the service providers. This may be performed, for example, by the correlation module 350 of PayPal Access 710.

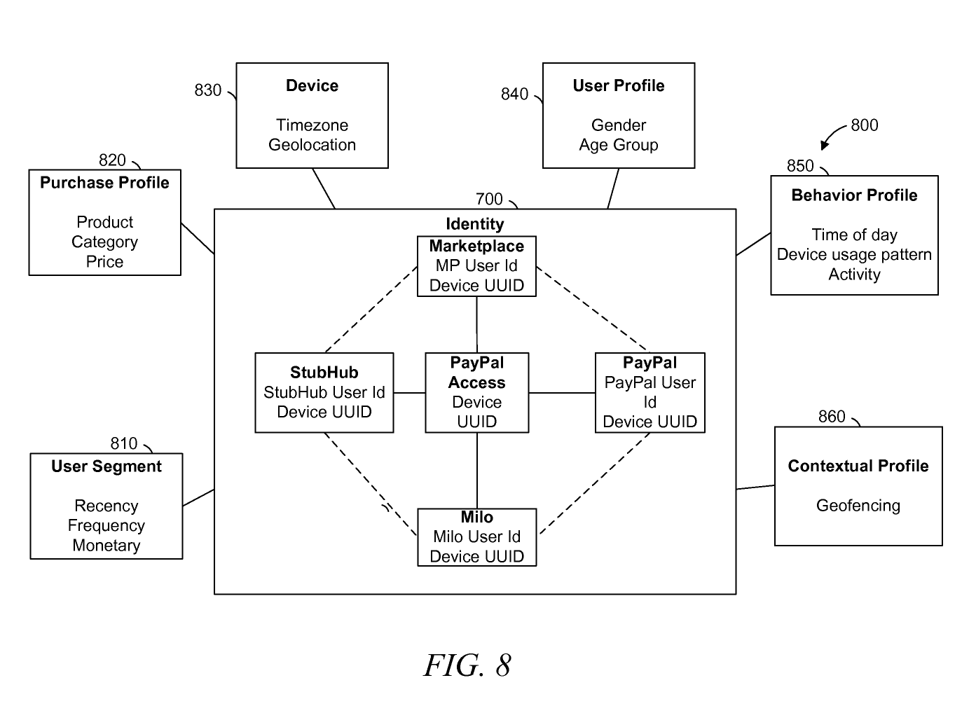

FIG. 8 is a block diagram 800 illustrating data relationships in particular example embodiments. Shown in the center of the figure is the network 700. FIG. 8 additionally shows data that may be gathered about the user from various sources. For example, information about recency and frequency of purchases, along with other financial or monetary data, may help identify the user segment 810. Likewise, information about products purchased, categories those products fall in, and price of those products may help identify a purchase profile 820 of the user. Mobile device data 830 may also be gathered from a mobile device used by the user. For example, timezone and geo-location information about the user may be included in the mobile device data 830. The user may have user profiles 840 with one or more service providers. The user profiles 840 may provide gender and age group of the user. Behavior profile data 850 may be determined from patterns of use of the user. For example, the user's usage pattern may be predictable based on a time of the day, a pattern of access (e.g., accessing one service at the same time as another service or after a transaction on the other service has completed), or location of the user (e.g., accessing certain services from one location that may correspond to a work location and other services from another location that may correspond to a home location). The contextual profile 860 for the user may be used to generate different content for the user based on content. For example, by comparing the geolocation data contained in the mobile device 830 with one or more geolocation targets, different targeted content can be served to the user based on the user's location.

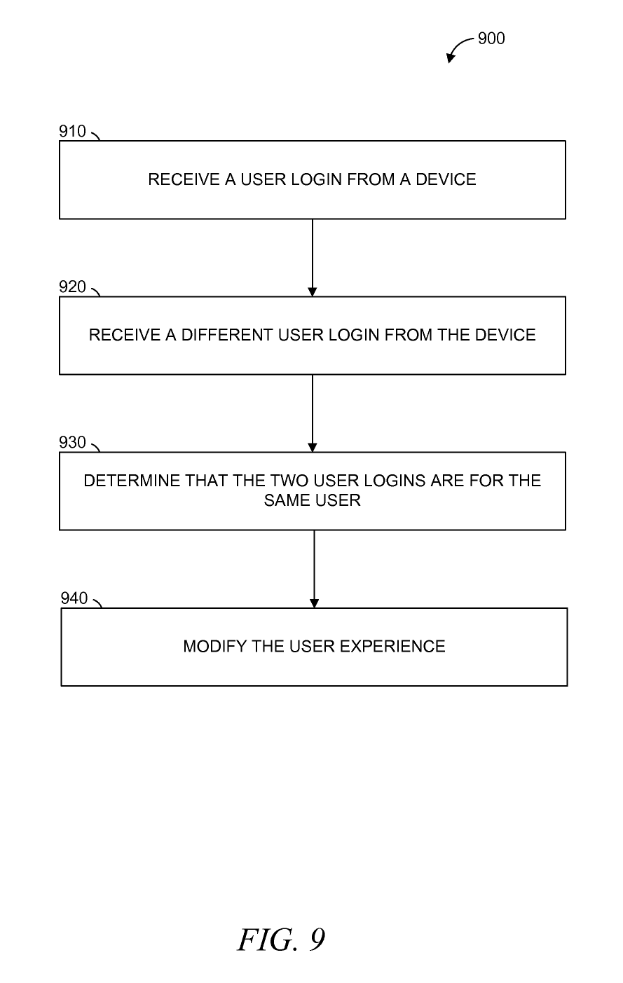

FIG. 9 is a flow diagram illustrating operations of the service providing machine 110 or the mobile identity machine 130 in performing a method 900 to determine that multiple user logins belong to the same user, according to some example embodiments. While the various operations of the method 900 are described in reference to the service providing machine 110 of FIG. 2 and the mobile identity machine 130 of FIG. 3, other devices or systems may be employed to perform the method 900 in alternative embodiments.

In operation 910, the mobile identity machine 130 performing the method 900 receives a user login from a device, e.g., device 141. The user login may be mediated by the service providing machine 110. For example, the user may log into a marketplace service (e.g., the marketplace 520A).

In operation 920, the mobile identity machine 130 receives a second user login from the same device, using different credentials or for a different service (e.g., one served by a different service providing machine 110). For example, the user may log into a ticket sales site (e.g., the ticket sales site 520B).

In operation 930, the mobile identity machine 130 may determine that the two user logins are actually for the same user based on the device being the same for both user logins. The device being the same may be determined by recognizing a UUID generated on the device (e.g., a hardware-defined UUID, a manufacturer-defined UUID, an operating-system-defined UUID, an application-defined UUID, a user-defined UUID, or any suitable combination thereof). For example, as shown in FIGS. 6-7 an adjacency identity may be determined based on the same device accessing two services.

In operation 940, the adjacency identity may be provided to one or both of the involved service providing machines 110. The service providing machines 110 may further use the information provided to alter the user experience (e.g., by presenting targeted advertisements, choosing different news articles to present, recommending different users to extend the user's social graph, etc.).

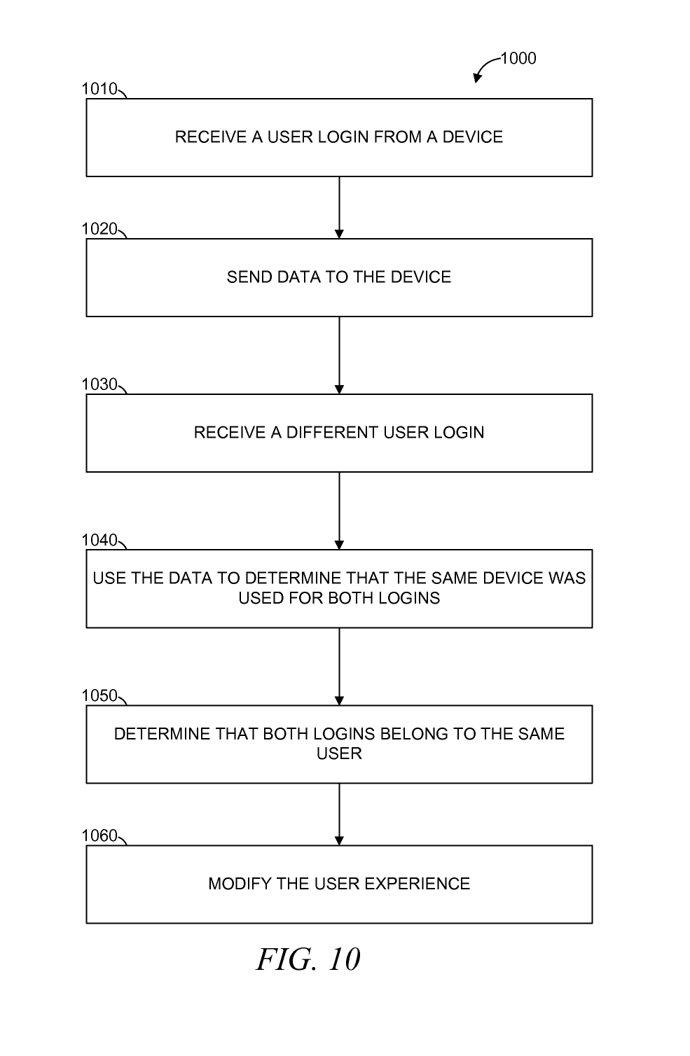

FIG. 10 is a flow diagram illustrating operations of the service providing machine 110 or the mobile identity machine 130 in performing a method 1000 to determine that multiple user logins belong to the same user, according to some example embodiments. While the various operations of the method 1000 are described in reference to the service providing machine 110 of FIG. 2 and the mobile identity machine 130 of FIG. 3, other devices or systems may be employed to perform the method 1000 in alternative embodiments.

In operation 1010, the mobile identity machine 130 or the service providing machine 110 performing the method 1000 receives a user login (e.g., a user name and password) from a device (e.g., the user device 141).

In operation 1020, data may be sent to the user device. For example, a cookie (e.g., a browser cookie, JavaScript object notation (“JSON”) data object, or other data record) may be stored on the user's device via a web browser. The cookie may contain a unique identifier for the user, the session, or both. The information in the cookie may also be stored in the mobile identity machine 130, (e.g., by storage module 330). In some example embodiments, the data may be generated by the mobile identity machine 130, transferred to the service providing machine 110, and then sent to the device (e.g., device 141).

In operation 1030, in another communication with the same device 141, the data sent to the device in operation 1020 may be retrieved. In some example embodiments, the data may be received by the service providing machine 110 and transferred to the mobile identity machine 130.

In operation 1040, the retrieved data may be used to determine that the same device was used for both the login of operation 1030 and the login of operation 1010. For example, the unique identifier stored in a cookie stored on the device 141 may be retrieved and compared to a stored copy of the unique identifier in a database. If the identifiers match, the determination that the same device 141 was used for both logins may be made.

In operation 1050, the mobile identity machine 130 determines that the user performing the second login is the same user as the user performing the first login, based on the determination that the same device 141 was used for both logins. As shown in FIG. 4, other criteria may be used to determine that the same user performed both logins, such as matching contact information for the two accounts or matching asset information for the two accounts.

In operation 1060, the service providing machine 110 modifies the user experience based on recognizing that the user of the second login is the same user as the user of the first login. For example, preferences stored for the account of the first login may be applied to the user interface generated for the user of the second login. As another example, advertising may be presented to the user based on information about the user gathered from the first account. To illustrate, if the user had identified particular interests using the first login, advertising relevant to users with those interests may be presented to the user when the user uses the second login.

According to various example embodiments, one or more of the methodologies described herein may facilitate identification of a user by a service provider. The identification of the user may allow the service provider to provide a more precisely customized experience to the user. This enhanced user experience may provide the service provider with a competitive advantage. For example, items viewed by a user accessing an online retailer may be tracked and shared with other service providers, allowing advertising to be targeted. Similarly, categories searched, brands bought, optimal notification choices (e.g., preferred device, preferred time, preferred place), average price of items purchased, total amount spent recently (e.g., over the last week, month, quarter, or year) may all be tracked and shared with other service providers. As another example, a user that chooses a preferred delivery method for one service provider may find that another service provider has pre-selected that delivery method as a default option, based on the shared user information from the user's mobile identity.

According to various example embodiments, one or more of the methodologies herein may facilitate identification of multiple devices associated with a user. The identification of the multiple devices may allow a service provider to direct communications more effectively. For example, if a user generally accesses a service from a laptop computer during the day and accesses the service from a mobile device at night, then a communication for the user may be directed to the laptop computer if sent during the daytime and to the mobile device if sent at night.

According to various example embodiments, one or more of the methodologies herein may facilitate the detection of fraud. For example, if a user creates an unusually large number of accounts (e.g., two or more or five or more) for a particular service, this may suggest that the user is attempting to engage in a large number of simultaneous fraudulent transactions while avoiding having any individual account shut down due to too many complaints. In another example, if fraud is detected on one account, preventative measures may be taken with respect to other accounts belonging to the same user.

FIG. 11 is a block diagram illustrating components of a machine 1100, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 11 shows a diagrammatic representation of the machine 1100 in the example form of a computer system and within which instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light emitting diode (LED) display, a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 (e.g., network 190) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, using a processor of a machine, a first user login comprising a first user identifier;
receiving a second user login comprising a second user identifier different from the first user identifier; and
determining that the first user identifier and the second user identifier both correspond to a user.

2. The method of claim 1, wherein:
the first user login is from a first device;
the second user login is from the first device; and
the determining that the first user identifier and the second user identifier both correspond to the first user is based on receiving both the first user login and the second user login from the first device.

3. The method of claim 2, further comprising, in response to receiving the first user login, transmitting data to the first device; wherein:
the receiving of the second user login includes receiving the data; and
the determining that the first user login and the second user login are both received from the first device is determined based on receiving the data.

4. The method of claim 1, further comprising:
receiving a first user preference associated with the first user login; and
applying the first user preference to a service associated with the second user login, based on the determination that the first user identifier and the second user identifier both correspond to the first user.

5. The method of claim 1, further comprising:
based on determining that the first user identifier and the second user identifier both correspond to the user, retrieving data associated with the first user login; and
customizing a user interface for presentation to the user via the second user login based on the retrieved data associated with the first user login.

6. The method of claim 1, wherein:
the first user login is for a first service; and
the second user login is for a second service.

7. The method of claim 6, further comprising:
determining that the first user login and the second user login have both received transactions from a particular financial account; and wherein
the determining that the first user identifier and the second user identifier both correspond to a first user is determined based on the determination that the first user login and the second user login have both received transactions from the particular financial account.

8. The method of claim 6, further comprising:
determining that the first user login and the second user login are both associated with a particular address; and wherein
the determining that the first user identifier and the second user identifier both correspond to a first user is determined based on the determination that the first user login and the second user login are both associated with the particular address.

9. The method of claim 6, further comprising:
determining that the first user login and the second user login are both associated with a particular financial account; and wherein
the determining that the first user identifier and the second user identifier both correspond to a first user is determined based on the determination that the first user login and the second user login are both associated with the particular financial account.

10. A system, comprising:
a processor of a machine;
a communication module configured to:
receive a first user login comprising a first user identifier;
receive a second user login comprising a second user identifier different from the first user identifier; and
an identification module configured to:
determine, using the processor of the machine, that the first user identifier and the second user identifier both correspond to a user.

11. The system of claim 10, wherein:
the first user login is from a first device;
the second user login is from the first device; and
the determining that the first user identifier and the second user identifier both correspond to the user is based on receiving both the first user login and the second user login from the first device.

12. The system of claim 11, wherein the communication module is further configured to in response to receiving the first user login, transmit data to the first device; wherein:
the receiving of the second user login includes receiving the data; and
the determining that the first user login and the second user login are both received from the first device is determined based on receiving the data.

13. The system of claim 10, wherein the communication module is further configured to:
receive a first user preference associated with the first user login; and
apply the first user preference to a service associated with the second user login, based on the determination that the first user identifier and the second user identifier both correspond to the user.

14. The system of claim 10, wherein:
the first user login is for a first service; and
the second user login is for a second service.

15. The system of claim 14, wherein the identification module is further configured to:
determine that the first user login and the second user login have both received transactions from a particular financial account; and wherein
the determining that the first user identifier and the second user identifier both correspond to the user is determined based on the determination that the first user login and the second user login have both received transactions from the particular financial account.

17. The system of claim 14, wherein the identification module is further configured to:
determine that the first user login and the second user login are both associated with a particular address; and wherein
the determining that the first user identifier and the second user identifier both correspond to the user is determined based on the determination that the first user login and the second user login are both associated with the particular address.

18. A non-transitory machine-readable storage medium comprising instructions that, when executed by one or more processors of a machine, cause the machine to perform operations comprising:
receiving a first user login comprising a first user identifier;
receiving a second user login comprising a second user identifier different from the first user identifier; and
determining that the first user identifier and the second user identifier both correspond to a user.

19. The non-transitory machine-readable storage medium of claim 18, wherein:
the first user login is from a first device;
the second user login is from the first device; and
the determining that the first user identifier and the second user identifier both correspond to the first user is based on receiving both the first user login and the second user login from the first device.

20. The non-transitory machine-readable storage medium of claim 18, wherein:
the first user login is for a first service; and
the second user login is for a second service.
